(19) United States
(12) Patent Application Publication
(10) Pub. No.: US 2026/0002509 A1
(43) Pub. Date: Jan. 1, 2026

(54) WAVE POWERED WINCH ASSEMBLY

(71) Applicant: TidalX AI Inc., Mountain View, CA (US)

(72) Inventor: Matthew Aaron Knoll, Mountain View, CA (US)

(21) Appl. No.: 19/247,259

(22) Filed: Jun. 24, 2025

Related U.S. Application Data
(60) Provisional application No. 63/664,306, filed on Jun. 26, 2024.

(51) Int. Cl. F03B 13/20; A01K 29/00; A01K 61/65

(52) U.S. Cl. CPC F03B 13/20; A01K 29/005; A01K 61/65

(57) ABSTRACT

The present disclosure relates to an aquatic powered winch assembly. The assembly includes a winch comprising a housing, a battery, and a motor assembly coupled to the battery. The battery and the motor assembly are disposed in the housing. The motor assembly includes a first motor and a second motor. A first winch line is coupled to the first motor, and a second winch line is coupled to the second motor. A device is movably coupled to the first winch line. The device is configured to transfer a motion to the motor assembly when a wave moves the device. The motor assembly is configured to convert the motion to a current or voltage.

### CROSS-REFERENCE TO RELATED APPLICATIONS

This application claims priority of U.S. Provisional Application No. 63/664,306 filed Jun. 26, 2024. The contents of the prior application is incorporated herein by reference in its entirety.

### TECHNICAL FIELD

The present disclosure relates to a wave powered assembly, and in particular, to a wave powered winch assembly.

### BACKGROUND

Aquaculture pens are installed in remote, off-shore locations, and are often out of reach of reliable power from a traditional power grid. Devices, such as cameras for monitoring various aspects of aquaculture pens consume power to operate.

### SUMMARY

The present disclosure relates to an aquatic powered winch assembly for generating power to operate devices, such as cameras, on site at remote, off-shore locations. The wave powered winch assembly is configured to convert natural, aquatic motion, such as waves, swells, tide, currents, etc., into power that can be used to operate the device moving in response to aquatic motion or relay generated power back to the pen for various applications on site. In the examples described herein, the wave powered winch assembly is used with a fixed aquaculture net installation, or fish pen and infrastructure. However, the wave powered winch assembly may be used in other aquatic applications.

In a first aspect, an aquatic powered winch assembly may include a winch comprising a housing, a battery, and a motor assembly coupled to the battery. The battery and the motor assembly may be disposed in the housing. The motor assembly may include a first motor and a second motor. A first winch line may be coupled to the first motor, a second winch line may be coupled to the second motor, and a device may be movably coupled to the first winch line. The device may be configured to transfer a motion to the motor assembly when a wave moves the device. The motor assembly may be configured to convert the motion to a current or voltage.

In a second aspect, a winch assembly for operating a camera may include a housing, a battery disposed in the housing, and a motor assembly disposed in the housing. The motor assembly may include a first motor and a second motor. The first and second motors may be coupled to the battery. A first winch line may be coupled to the first motor, and a second winch line may be coupled to the second motor. The motor assembly may be configured to convert a movement in one or more of the first and second winch lines into a current or voltage and may transfer the current or voltage to the battery.

In a third aspect, a fish pen system may include a fish pen and a winch assembly operably coupled to the fish pen. The winch assembly may include a winch comprising a housing, a battery, and a motor assembly coupled to the battery. The battery and the motor assembly may be disposed in the housing. The motor assembly may include a first motor and a second motor. A first winch line may be coupled to the first motor, and a second winch line may be coupled to the second motor. A camera may be movably coupled to the first winch line. The camera may be configured to transfer a movement to the motor assembly when a wave moves the camera. The motor assembly may be configured to convert the movement to a current or voltage.

### Definitions

As used herein, the term “about” means +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

Some examples may be described using the expression “coupled” and “connected” along with their derivatives. For example, some arrangements may be described using the term “coupled” to indicate that two or more elements are in direct physical or electrical contact. The term “coupled,” however, may also mean that two or more elements are not in direct contact with each other, but yet still co-operate or interact with each other. The examples described herein are not limited in this context.

Other features and advantages of the present disclosure will be apparent from the following detailed description, figures, and claims.

### BRIEF DESCRIPTION OF THE DRAWINGS

FIG. 1 is a diagram of an aquaculture net installation and winch assembly for maneuvering a camera assembly and is assembled in accordance with the teachings of the present disclosure; and

FIG. 2 is an interior view of a winch of the winch assembly of FIG. 1.

### DETAILED DESCRIPTION

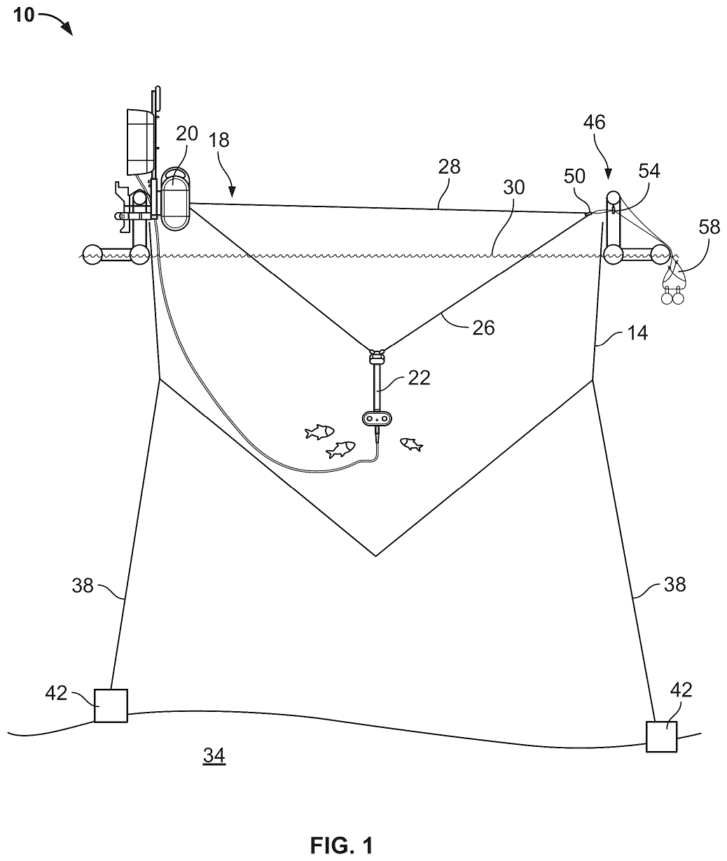

The present disclosure relates to an aquatic wave powered winch assembly for an aquaculture net installation that is configured for generating power on site at remote, off-shore locations. The wave powered winch assembly is configured to convert natural, aquatic motion, such as waves, swells, tide, currents, etc., into power that can be used for various applications on site. In one non-limiting example shown in FIG. 1, an aquaculture net installation system 10 includes a fish pen 14 and winch assembly 18 that movably operates a suspended underwater camera assembly 22. The camera assembly 22 is movably coupled on a winch line 26 of the assembly 18. So configured, aquatic motion that moves the camera assembly can generate a power that may be stored on a battery in a winch 20 of the winch assembly 18. The schematic in FIG. 1 could be scaled to a variety of pen sizes and work in environments where there is little to no reliable power source.

The wave powered winch assembly 18 is integrated with the fish pen 14 that is positioned at a water surface 30 and anchored to a sea floor 34 by one or more anchor lines 38 and anchors 42. The fish pen 14 may be one of a dozen separate large fish pens of a farm, such as, for example, a salmon farm, where each fish pen 14 measures approximately 50 to 100 meters in diameter. Fish farms may have a variety of different power needs. For example, some farms provide lighting to affect the quality and growth of the fish, utilize cameras for monitoring the fish, and feed the fish using automated feeding systems. According to the present disclosure, fish farms that utilize the example wave powered winch assembly can generate power to self-drive various devices operated by the winch assembly 18. The assembly 18 may provide a sustainable, clean supplementary power source to remote fishing farms.

The winch assembly 18 includes first and second winch lines 26, 28 that span across the diameter of the pen 14 and connect to a pulley system 46. The winch lines 26, 28 are coupled to a first pulley 50 above the water surface 30 and located opposite from the winch 20 on the pen 14. A second pulley 54 of the pulley system 46 couples the winch lines 26, 28 to a counter-weight 58.

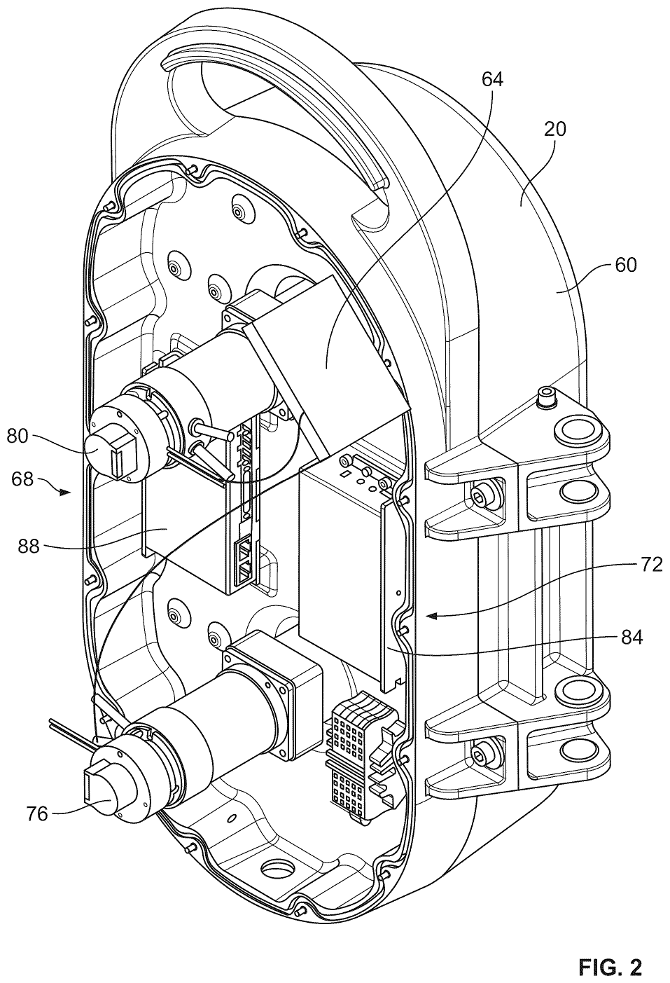

In FIG. 2, the winch 20 includes a housing 60, a battery 64, a motor assembly 68 coupled to the battery 64, and a motor controller assembly 72 operably coupled to the motor assembly 68. The battery 64, the motor assembly 68, and the motor controller assembly 72 are disposed in the housing 60.

The motor assembly 68 includes a first motor 76 and a second motor 80. The first motor 76 is coupled a first spool of line (hidden from view) disposed in the housing 60 and attached to the first winch line 26; the second motor 80 is coupled to a second spool of line (hidden from view) disposed in the housing 60 and attached to the second winch line 28. The motor controller assembly 72 includes a first controller 84 operably coupled to the first motor 76, and a second controller 88 operably coupled to the second motor 80. The first and second motors 76, 80 are also coupled to the battery 64. To position the camera assembly 22 or other device (e.g., lights, fish feeder, etc.) coupled to the first winch line 26, an operator may communicate with the motor controller assembly 72 to operate each motor 76, 80. Each motor 76, 80 is operated to either pull (i.e., apply tension) or release (i.e., provide slack) the first and second winch lines 26, 28 from their respective spools disposed in the winch 20. By operating the winch lines 26, 28 separately, the winch 20 positions the camera assembly 22 at a desired depth relative to the water surface 30 and within a particular area of the pen 14.

Returning back to FIG. 1, the camera assembly 22 is movably coupled to the first winch line 26 and is disposed under water. The winch 20 can change the position of the camera assembly 22 or hold the camera assembly 22 still in a particular position. With the natural movement of waves, the camera assembly 22 moves (e.g., sways or bobs) relative to the pen 14. As the camera assembly 22 moves with the motion of the waves, the camera assembly 22 transfers that motion to the motor assembly 68 of the winch assembly 22. The motor assembly 68 acts as a generator and converts the motion transferred to the winch assembly 22 to current and/or voltage. The battery 64 is configured to receive the current/voltage from the motor assembly 68 (via the connections to each motor) and store the current/voltage. The battery 64 may be configured to power the motor assembly 68 and/or various features and operations of the camera assembly 22 (e.g., controlling the flash, focusing the lens, capturing images, etc.). In this way, the winch 20 is configured to capture wave energy by harvesting the movement of the camera assembly 22.

In some examples, the winch 20 and/or camera assembly 22 may include one or more of an accelerometer or inertial measurement unit (IMU), each configured to determine an amount of voltage/current that is transferable to the motor assembly 68 from the wave-induced movement of the camera assembly 22. For example, the camera assembly 22 may include both an accelerometer that measures changes in motion, and an IMU that measures velocity. In this way, the winch 20 may be programmed to detect the movement of the camera assembly 22 and determine the amount of power being generated (or capable of being generated) from the wave-induced movement of the camera assembly 22. The data captured by the accelerometer and/or IMU may be transmitted and analyzed to help determine an operational mode of the winch 20. In yet another example, the camera assembly 22 may include additional weight to produce more power.

The wave powered winch assembly 18 described herein advantageously captures power at a remote, off-shore location using natural ocean dynamics, thereby providing a sustainable power source to devices operated in fishing pens or other off-shore facilities. The power captured by the disclosed assemblies can provide power to enable pen automation and provide power to other on-site power needs. During large storms, rather than lose power (due to damage of traditional power structures), the pens equipped with the disclosed assemblies can actually take advantage of the storm conditions to generate and store more power.

While this specification contains many specific implementation details, these should not be construed as limitations on the scope of any disclosure or of what may be claimed, but rather as descriptions of features that may be specific to particular examples of particular disclosures. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples, and it should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. An aquatic powered winch assembly, the assembly comprising:
a winch comprising a housing, a battery, and a motor assembly coupled to the battery, the battery and the motor assembly disposed in the housing, the motor assembly comprising a first motor and a second motor;
a first winch line coupled to the first motor;
a second winch line coupled to the second motor; and
a device movably coupled to the first winch line,
wherein the device is configured to transfer a motion to the motor assembly when a wave moves the device, the motor assembly configured to convert the motion to a current or voltage.

2. The assembly of claim 1, wherein the motor assembly transfers the current or voltage to the battery.

3. The assembly of claim 1, wherein the battery of the winch provides power to the motor assembly of the winch.

4. The assembly of claim 1, wherein the battery is coupled to the first motor of the winch.

5. The assembly of claim 1, wherein the battery is coupled to the second motor of the winch.

6. The assembly of claim 1, comprising a pulley coupled to the first and second winch lines.

7. The assembly of claim 6, comprising a weight coupled to the pulley.

8. The assembly of claim 1, wherein the device is an underwater camera.

9. The assembly of claim 1, comprising an accelerometer coupled to the device or winch and configured to determine an amount of current or voltage that is converted by the motor assembly.

10. The assembly of claim 1, comprising an inertial measurement unit coupled to the device or winch and configured to determine an amount of current or voltage that is converted by the motor assembly.

11. The assembly of claim 1, comprising a motor controller assembly coupled to the motor assembly.

12. The assembly of claim 11, wherein the motor controller assembly comprises a first motor controller operably coupled to the first motor and a second motor controller operably coupled to the second motor.

13. A winch assembly for operating a camera, the winch assembly comprising:
a housing;
a battery disposed in the housing;
a motor assembly disposed in the housing and comprising a first motor and a second motor, the first and second motors coupled to the battery;
a first winch line coupled to the first motor; and
a second winch line coupled to the second motor,
wherein the motor assembly is configured to convert a movement in one or more of the first and second winch lines into a current or voltage and transfer the current or voltage to the battery.

14. (canceled)

15. The assembly of claim 13, comprising an accelerometer coupled to the winch and configured to determine an amount of current or voltage that is converted by the motor assembly.

16. The assembly of claim 13, comprising an inertial measurement unit coupled to the winch and configured to determine an amount of current or voltage that is converted by the motor assembly.

17. The assembly of claim 13, wherein the first winch line is coupled to a first spool that is disposed in the housing.

18. The assembly of claim 13, wherein the second winch line is coupled to a second spool that is disposed in the housing.

19. The assembly of claim 13, comprising a motor controller assembly coupled to the motor assembly.

20. (canceled)

21. The assembly of claim 13, further comprising a device movably coupled to the first winch line, the motor assembly configured to move the device by operating one or more of the first and second winch lines.

22-23. (canceled)

24. A fish pen system comprising:
a fish pen;
a winch assembly operably coupled to the fish pen, the winch assembly comprising:
a winch comprising a housing, a battery, and a motor assembly coupled to the battery, the battery and the motor assembly disposed in the housing, the motor assembly comprising a first motor and a second motor;
a first winch line coupled to the first motor;
a second winch line coupled to the second motor; and
a camera movably coupled to the first winch line,
wherein the camera is configured to transfer a movement to the motor assembly when a wave moves the camera, the motor assembly being configured to convert the movement to a current or voltage.
